(19) United States
(12) Patent Application Publication
(10) Pub. No.: US 2016/0098749 A1
(43) Pub. Date: Apr. 7, 2016

(54) SYSTEM AND METHOD FOR MEDIA DISTRIBUTION

(71) Applicant: Audiolation, LLC, East Grand Rapids, MI (US)

(72) Inventors: Alexander Michael Bates, Ada, MI (US); Richard Kolk, East Grand Rapids, MI (US); David L. Bratschie, East Grand Rapids, MI (US)

(21) Appl. No.: 14/872,440

(22) Filed: Oct. 1, 2015

Related U.S. Application Data
(60) Provisional application No. 62/058,235, filed on Oct. 1, 2014.

(51) Int. Cl. G06Q 30/02

(52) U.S. Cl. CPC G06Q 30/0255; G06Q 30/0269

(57) ABSTRACT

A system and method for digital media distribution wherein a media creator may provide digital media to a distribution system or distribution company, and wherein a media consuming user may obtain the media creator's digital media via the distribution system in exchange for viewing one or more advertisements.

### CROSS-REFERENCE TO RELATED APPLICATIONS

The present application claims the benefit of U.S. Provisional Patent Application No. 62/058,235, filed Oct. 1, 2014, which is incorporated by reference herein in its entirety.

### BACKGROUND OF THE INVENTION

In the computer age, digital distribution of many forms of media, including music, movies, books, artwork, etc., has become widespread. The ease of transferring digital media data over high-speed internet connections has increased the likelihood that a portion of the digital distribution may occur without compensating or payment for the media. In some instances, direct payment to a distribution company, or to right holders of the digital media may be possible and/or practical. Some media consumers may find ways and/or methods of indirect payments, or methods and/or systems utilizing services in exchange for the digital media, preferable to direct payment methods.

### SUMMARY OF THE INVENTION

In one aspect, the invention relates to a method of operating a computer-implemented media distribution system over a global computer network, comprising the steps of: receiving a request from an authenticated user for at least one unit of media; providing a response to the request with at least one computer-selected advertisement; requiring the authenticated user to consume the at least one computer-selected advertisement and provide a response representative of the completion of the consumption of the at least one computer-selected advertisement; receiving the response representative of the completion of the consumption of the at least one computer-selected advertisement from the authenticated user; validating the response representative of the completion of the consumption of the at least one computer-selected advertisement from the authenticated user; and providing, upon a successful validation step, the at least one unit of media in downloadable form to the authenticated user over the global computer network.

Several different embodiments of the invention are disclosed in this application, and others will be apparent to one skilled in the art of the area to which this invention pertains. The step of receiving a request from an authenticated user for at least one unit of media can comprise the step of receiving a request from an authenticated user for a plurality of units of entertainment media. The step of providing a response to the request with at least one computer-selected advertisement can comprise an audiovisual advertisement and at least one question to be presented to the authenticated user. The at least one question can be presented to the authenticated user in a multiple-choice user interface. The step of providing a response representative of the completion of the consumption of the at least one computer-selected advertisement can include the step of selecting at least one of the multiple-choice responses on the user interface.

The authenticated user can have at least one demographic data element associated with it and the at least one computer-selected advertisement comprises an advertisement responsive to the at least one demographic data element. The step of providing a response to the request with the at least one computer-selected advertisement can include selecting the at least one computer-selected advertisement based on a correlation between the at least one demographic data element associated with the authenticated user and at least one target demographic data element associated with the at least one computer-selected advertisement. The step of providing a response to the request with the at least one computer-selected advertisement can include determining whether the correlation between the at least one demographic data element associated with the authenticated user and at least one target demographic data element associated with the at least one computer-selected advertisement satisfies a correlation threshold. The at least one demographic data element can include at least a two of name, age, gender, address, zip code, phone number, religion, ethnicity, marital status, family size, number of roommates, housing status, field of work, years in field of work, personal or professional interests, school attended or attending, or hobbies.

The step of requiring the authenticated user to consume the at least one computer-selected advertisement can further include determining whether the authenticated user is using at least one of a program or software configured to prevent the authenticated user from consuming the at least one computer-selected advertisement. The method can also include the step of, when the step of determining concludes the program or software configured to prevent the authenticated user from consuming the at least one computer-selected advertisement is being used, not providing the least one unit of media in downloadable form to the authenticated user over the global computer network. The method can also include the step of, when the step of determining concludes the program or software configured to prevent the authenticated user from consuming the at least one computer-selected advertisement is being used, providing the authenticated user a message indicating that a program or software is being configured to prevent the authenticated user from consuming the at least one computer-selected advertisement is being used.

The step of providing the at least one unit of media in downloadable form to the authenticated user over the global computer network can further include providing the authenticated user a single-use download link, such that the link is only operational to download the at least one unit of media once. The method can also include the step of logging the step of providing the at least one unit of media in downloadable form to the authenticated user. The method can also include the step of compensating a rights-holder for the at least one unit of media based on the logging.

### BRIEF DESCRIPTION OF THE DRAWINGS

In the drawings:

FIG. 1 is a flow chart showing the different physical and digital components of the method of distribution.

FIG. 2 is a flow chart showing the path that users follow on the site.

FIG. 3 is an example of a user website welcome page.

FIG. 4 is an example registration website.

FIGS. 5-9 illustrate an example member registration website.

FIG. 10 illustrates an example welcome website for a band user.

FIG. 11 illustrates an example user song search website.

FIG. 12 illustrates an example advertisement webpage.

FIG. 13 illustrates an example feedback webpage for the viewed advertisement.

FIG. 14 illustrates another example advertisement webpage.

FIG. 15 illustrates another example feedback webpage for the viewed advertisement.

FIG. 16 illustrates an example confirmation website.

FIGS. 17 and 18 illustrate an example band account registration website.

FIG. 19 illustrates an example website showing successful registration.

FIG. 20 illustrates an example music upload website for a band user.

FIG. 21 illustrates an example website showing confirmation the music has been uploaded successfully.

FIG. 22 illustrates an example website administration portal.

FIGS. 23 and 24 illustrate an example website for adding a new advertisement.

### DESCRIPTION OF EMBODIMENTS OF THE INVENTION

Embodiments of the invention herein relate to a method and system for the distribution of digital data, such as data comprising digital media, between one or more end users, one or more media creators, and one or more distribution system and/or distribution management entities. As used herein, “digital media” may be used to collectively refer to any type of media information which may comprise audio or music, pictures, artwork, drawings, text, books, compositions, performance, or recitation and/or reproduction of any of the aforementioned categories. In this sense, “digital media” may collectively refer to any time of information, or digital recreation of information that may be otherwise protected by United States and/or international copyright laws, rules, and/or regulations. Furthermore, while copyrighted works are described, copyrighted works are merely one non-limiting example of digital media that may be included herein.

While foregoing examples of the method and system included herein may include one or more embodiments related specifically to music and/or audio distribution, embodiments of the invention may include all forms of digital media, as explained above. Additionally, while a “media creator” is described as a party to the method and/or system, any user or entity that may own, develop, create, draft, or be assigned rights in the digital media may be included. Non-limiting examples of “media creators” may include musicians, artists, choreographers, authors, rights management companies, recording label entities, corporations, trademark holders, and/or photographers.

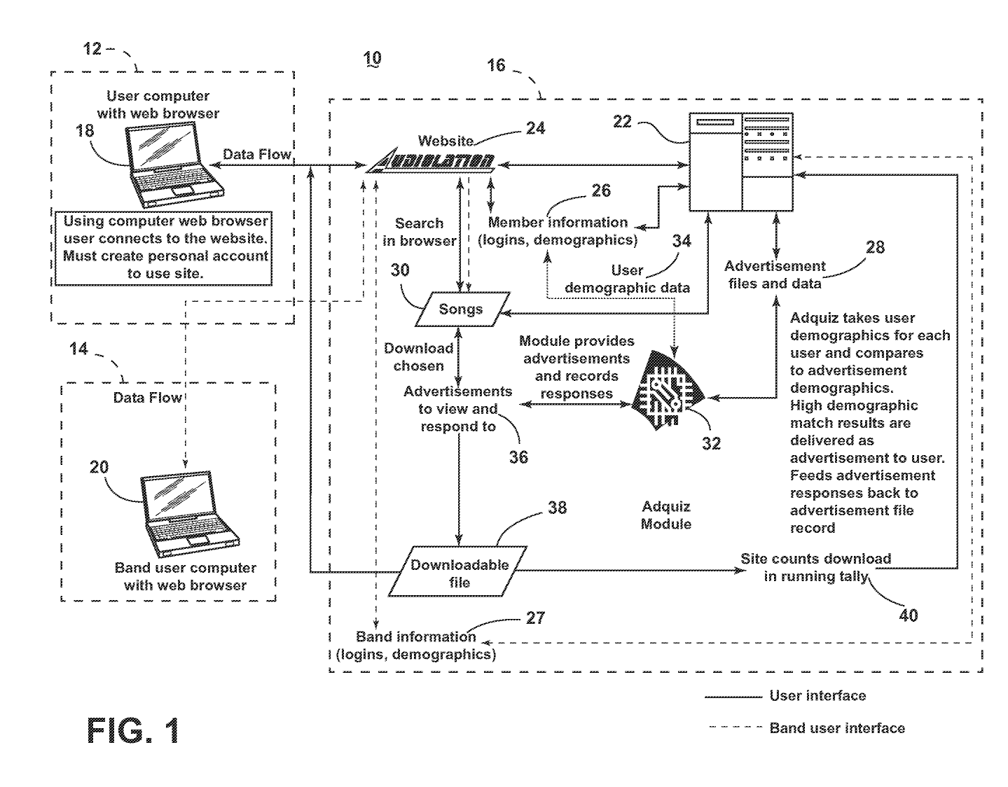

FIG. 1 illustrates one example embodiment of a method of digital media distribution 10. The method of distribution 10 may include at least one end user 12, at least one media creator 14, and at least one distribution system 16. The end user 12 may be any entity capable of receiving digital media via, for example, a computer 18 communicatively coupled with the distribution system 16. For example, the computer 18 may be communicatively coupled via the Internet, to provide for data communication between the entities 12, 16. The media creator 14 may also interact with the method of distribution 10, and be capable of sending digital media, for example, by way of a second computer 20 communicatively coupled with the distribution system 16, via the Internet. The distribution system 16 may further comprise one or more servers 22 configured to store, organize, and service or process the transactions and/or interactions of the method of distribution 10, as well as the transactions and/or interactions with either the end user 12 and/or media creator 14.

Each of the computers 18, 20 and/or servers 22 may include one or more controllers and memory, for example, random access memory (RAM), read-only memory (ROM), flash memory, or one or more different types of portable electronic memory, such as discs, DVDs, CD-ROMs, etc., or any suitable combination of these types of memory. The controller may include one or more processors 28, which may be running any suitable programs.

While a non-limiting example of data communication via the Internet is shown, embodiments of the invention are not so limited to the particular method or medium of data communication, and additional communication methods and mediums may be included, such as file transfer protocols, UseNet, bit torrent, peer-to-peer, cellular communications, Wi-Fi, Bluetooth, ZigBee, etc. Furthermore, while computers 18, 20 are illustrated, embodiments of the invention may include any communicatively electronic device, which may include smartphones, touchscreen tablets, interactive televisions, cable distribution boxes, network connected storage devices, streaming audio systems, etc. Additional electronic devices may be included.

Each of the end user computer 18 and media creator computer 20 may be communicatively coupled with an interface, such as website 24, for interacting with the method 10 and/or distribution system 16. The website 24 may act as an interactive portal for the end user 12 and/or media creator 14 to perform requested transactions and/or services within the method 10 as described herein. In this sense, the website 24 may be understood as a “front end” interface for “back end” transactions that may take place in the server 22. For ease of understanding, service transactions between the end user 12 and the distribution system 16 are illustrated as a solid line, while service transactions between the media creator 14 and the distribution system 16 are illustrated as dotted lines. While no illustrated interactions are shown directly between the end user 12 and media creator 14, embodiments of the invention may include direct and/or bidirectional interactions between the entities 12, 14, accounting for some management of the transaction via the distribution system 16. Additionally, while a website 24 is described, alternative portals for the method 10 may be included, non-limiting examples including dedicated applications, smartphone applications, etc.

The distribution system 16 and/or server 22 may further include at least a portion of member or user information 26, such as login information and/or demographics, media creator information, such as band information 27 login information and/or demographics, at least a portion advertisement files and data 28, one or more digital media files, such as songs 30, or catalogs of songs, and an adquiz module 32. Each of the member information 26, band information 27, advertisement files and data 28, songs 30, and adquiz module 32 may include computer searchable databases stored, for example, in memory on the one or more servers 22, or may include or be located in one or more individual components located remotely from the server 22. The webpage 24 and/or server 22 may be further configured to interact with at least one of the member information 26, the band information 27, the advertisement files and data 28, the songs 30, and the adquiz module 32.

The computer searchable database may be accessible by the processor, which may run a set of executable instructions to access the database. Alternatively, the controller may be operably coupled to a database of information. For example, such a database may be stored on an alternative computer or controller. It will be understood that the database may be any suitable database, including a single database having multiple sets of data, multiple discrete databases linked together, or even a simple table of data. It is contemplated that the database may incorporate a number of databases or that the database may actually be a number of separate databases.

Additionally the adquiz module may include one or more programs for determining the one or more advertisements to be provided to the end user 12. The program may include a computer program product that may include machine-readable media for carrying or having machine-executable instructions or data structures stored thereon. Such machine-readable media may be any available media, which can be accessed by a general purpose computer and/or server, a special purpose computer and/or server, or other machine with a processor. Generally, such a computer program may include routines, programs, objects, components, data structures, algorithms, etc. that have the technical effect of performing particular tasks or implement particular abstract data types. Machine-executable instructions, associated data structures, and programs represent examples of program code for executing the exchange of information as disclosed herein. Machine-executable instructions may include, for example, instructions and data, which cause a general purpose computer and/or server, special purpose computer and/or server, or special purpose processing machine to perform a certain function or group of functions. In implementation, one or more determinations of which computer-selected advertisements may be provided to an end user 12 may be converted to an algorithm, which may be converted to a computer program comprising a set of executable instructions, which may be executed by a controller.

When an end user 12 interacts with the website 24, the user 12 may search the songs 30 for a digital song file, for example, by an artist or title, which may present the user with search results. If the user 12 determines they would like a digital copy of a particular song 30, they may choose to initiate a download transaction for a particular digital copy of the particular song 30. The website 24 and/or server 22 utilizes member information 26 related to that end user 12, or a group of end users 12, and provides at least a portion of user demographic data 34 to the adquiz module 32. The portion of demographic data 34 may include a subset of the member information 26, or a computed summary, for example, by an algorithm performed by at least one of the website 24 and/or server 22, wherein the summary is indicative of at least a portion of the member information 26.

The adquiz module 32 determines at least one advertisement 36 to provide to the end user 12, based on at least one of the user demographic data 34, as well as the advertisement files and data 28 available, and provides the at least one advertisement 36 to the user 12. In one example, the advertisement files and data 28 may include advertisement data related to a target audience for one or more advertisement files, where the advertisement is tailored to a particular group or demographic, which may be defined by an advertiser, the server 22, and/or website 24, and may be indicated by the user demographic data 34 provided to the adquiz module 32. In this example, the adquiz module 32 may utilize at least a portion of the user demographic data 34 for each user 12, and compare the user demographic data 34 to advertisement demographic data. If a high demographic match between the user demographic data 34 and the advertisement demographic data results, the advertisement 36 with matching demographic data may be delivered and/or provided to the end user 12.

While a “high” demographic match is described, embodiments of the invention may include varying levels of “high” or “matching” that takes place between the data. For example, the method 10 may include a “highest” match, even if that “highest” match is a relatively “low” match when viewed in the abstract. Alternative embodiments may include only displaying advertisements 36 that reach at least a minimal match level or threshold, or “satisfies” a minimal match threshold. The term “satisfies” the threshold is used herein to mean that, for example, a comparison of the demographic match between the user 12 and the advertisement files and data 28 satisfies the predetermined threshold, such as being equal to or less than the threshold value. It will be understood that such a determination may easily be altered to be satisfied by a positive/negative comparison or a true/false comparison. The match threshold value may set by at least one of an advertiser, end user 12, media creator 14, website 24, server 22, and/or adquiz module 32.

The end user 12 is presented the “matched” advertisement 36, and may be further requested or required to respond to the advertisement 36 in some form. Once the end user 12 has viewed the advertisement 36, and responded if necessary, the user will be presented with a downloadable file 38, or link to a downloadable file 38, to obtain a copy of the song 30 the user 12 had selected. At least one of the website 24 and/or server 22 may further keep track or running tally 40 of the number of digital media downloads, advertisements 36 viewed, or end user 12 downloads and/or advertisements 36 viewed, which may be stored in the server 22, and/or incorporated into the demographic information 26, 34, 28.

The media creator 14 may interact with the website 24 and/or server 22 to provide one or more digital media files, such as songs 30 to be distributed by the method 10. In this activity, the media creator 14 may provide or upload the one or more songs 30 to the website 24 and/or server 22 such that the song 30 is incorporated into the searchable catalog of songs 30 provided to the end users 12. The website 24 and/or server 22 may convert the song 30 provided by the media creator 14 into a downloadable file 38. The media creator 14 may further define demographical information for their entity as a whole, or provide demographical information for each individual or group of songs 30. When an end user 12 is distributed the digital media song 30 by way of the method, the media creator 14 may be compensated by the distribution system 16 (or owners thereof), based on, for example, the running tally 40 of the number of downloads, or advertisements 36 viewed by the end user 12, or a percentage of a the advertising revenue generated by the advertisement. Additional considerations may include the popularity of the song compared to the popularity of the catalog of songs 30, or individual contractual agreements the media creator 14 may have with the distribution system 16.

While demographical information is described herein relating to the end user 12, media creator 16, advertisements 36, and/or songs 30, it may be understood that such information may be entered by each of the respective parties, or may be interpreted from other information related to each of the respective parties. In this sense, the demographical information used may include metadata related to, but not explicitly provided by the respective parties. For example, the Internet protocol (IP) address of an end user may provide geographical metadata for that user. Similarly a trace route of an end user's IP address may reveal the Internet service provider of the end user 12, regardless of the end user 12 providing that information explicitly. Additional examples of metadata may be included.

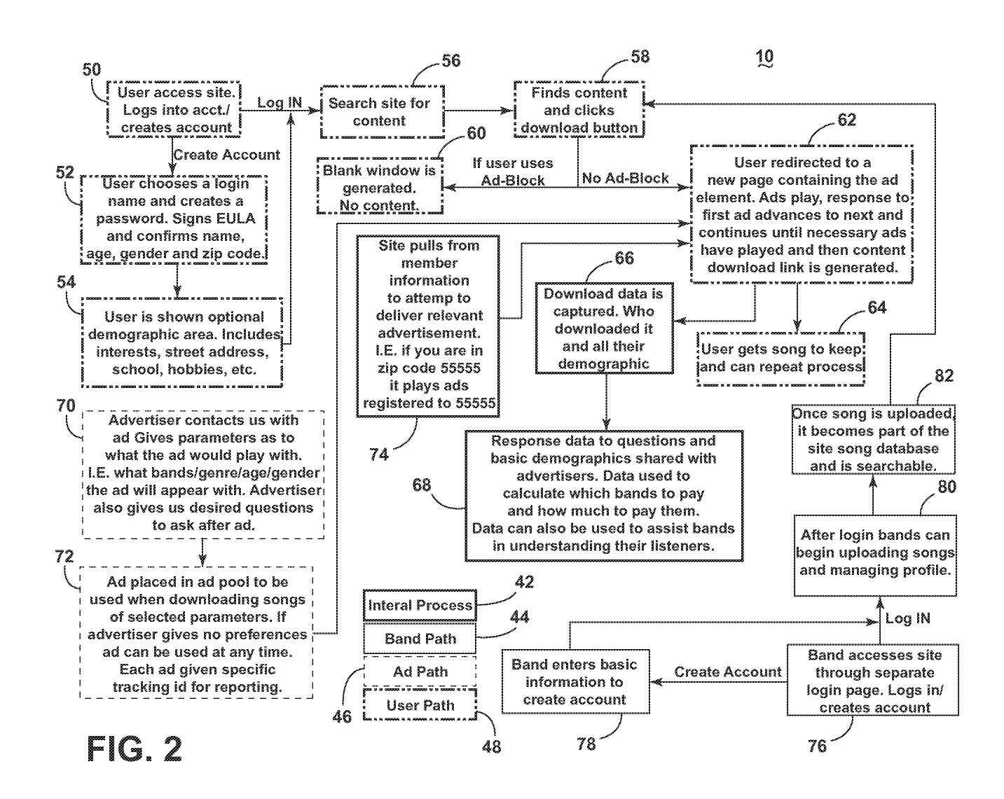

FIG. 2 illustrates further interactions between the entities of FIG. 1, which may be included in the method 10. FIG. 2 provides different indicated designations, for example, based on who is performing a particular action, or providing a particular result. These designations may include, but may not be limited to, an internal process 42, for example, internal to the website, server, distribution system, or distribution company operating the system), a band path 44, for example, a path or action a media creator takes or provides, an advertising path 46, for example, a path for an advertisement or actions an advertiser provides, and a user path 48, showing user interactions with the method 10 and/or distribution system. While the paths are shown “owned” or “belonging” to a particular group or user indicated, embodiments of the invention may include alternative examples wherein one or more transactions, interactions, or “ownerships” may be rearranged to another user/path, and it is understood that embodiments of the invention are not only limited to the example illustrated and/or described.

First, an end user accesses the website 50 and may either log into their account, if an account exists, or may choose to create an account, if an account does not exist. If an account does not exist, or the end user would otherwise like to create and account, the user may choose a “create account” option, and may advance to a transaction wherein the user chooses a login name and creates a password 52. The user at this time may also confirm their name, age, gender, zip code, and other demographical information, as well as review and agree to an end user license agreement (EULA). Additional user inputs may be included, and the EULA may vary depending on the user inputs and/or demographical information.

The transaction may also limit only users of a particular status, for example, a geographic location or minimum age, to perform the account creation. Next, a user is shown additional optional input fields 54, such as a demographical area or map wherein they may select their location, personal or professional interests, street address, school attended or attending, hobbies, and the like. Additional mandatory and/or optional user inputs may be included. Once the user has completed the account creation, and the server has been updated to include the member information, the user may login to the website. Alternatively, the user may be allowed to login prior to the server updating the member information (e.g. done at a later date and/or time, or in a batch operation), or the user may need to verify input information, for example, by confirming the email address used in creating the account. Additional steps and/or transactions may be included.

Once the authenticated user has logged into the website 56, they may proceed to search the website for at least one unit of particular content or a digital media unit they would like to obtain. The user may, for example, click a download button 58 to initiate the distribution of the digital media. The website may be further configured such that the user will not receive the digital media content unless they first complete a predetermined transaction, for example, by watching, consuming, or viewing one or more computer-selected advertisements presented to them, and possibly responding, validating, or replying to particular questions or interactions, post-viewing, to confirm they viewed the advertisement, or to provide a response based on the advertisement. If the user does not complete the predetermined transaction, the user will not be provided access to obtain the digital media content.

The website may be further configured to scan for, detect, or react in response to user programs or software which may otherwise prevent the user from performing the predetermined transaction, and/or obtaining the digital media content without the user from performing the predetermined transaction. For example, if a user uses a “blocker” or “advertisement blocker,” such as a web browser plug-in to disable or otherwise block advertisements 60 on the distribution system website may not be able to provide the user with the necessary transaction (e.g. advertisement to view). In this instance, the website may provide the user an indication that a “blocker” is being used, not provide any viewing, not provide the digital media content to the user, and/or provide the user with an explanation that the transaction (e.g. viewing) is necessary as a precursor to obtain the digital media content. For example, the website may provide the user with instructions to disable the “blocker,” or provide alternative instructions for how to comply with the predetermined transaction requirements, for example, by including a redirect link, or providing the user a way to contact technical or customer support if the “blocking” indication is provided in error.

If the user is not using a “blocker,” and/or the website determines not “blocking” is occurring, the user may view the advertisement, or be redirected 62 to a new page containing the advertising element for viewing. As the one or more advertisements are viewed, the website may, for example, require the user provide some interaction or response after each advertisement, or may require the user provide responses to more than one advertisement after a number of advertisements have been viewed. After all the advertisements have played, and all the responses necessary have been entered by the user, the website may generate a digital media content download link, and provide the link to the user. The user may then follow the download link and obtain the digital media content 64. From here, the user may repeat the process to obtain additional digital media content, if desired.

Embodiments of the invention may include examples, wherein the download link provided to the user is a single-use link, such that the link is only operational to download the digital media content once. Embodiments of the invention may also include digital copyright management software or functions wherein, for example, the digital media content is “keyed” to only operate for the particular end user that obtained it, or in another example, the digital media content may “expire” after a period of time, wherein the downloaded file will become unplayable or otherwise non-functional to perform the digital media. Additional embodiments including rights management functions may be included.

After the website has provided the user with a generated download link, and/or after the user obtains the digital media content, the website and/or server may capture data related to the transaction 66 (e.g. the advertisement, user responses, user data, user demographic data, user download history, etc.). At least some of the captured data may further be shared with third parties 68, who may be external or unrelated to the website, such as the advertisers. At least some of the captured data may also be used to calculate which bands or media creators may need to be paid based on the distribution of the digital media content, and how much to pay in each instance. For example, one or more algorithms may be accessed, processed, and/or otherwise used to calculate a dynamic or predetermined fee. The fee payment may be, for example, processed immediately, delayed, batch processed at a later date, etc. Embodiments of the invention may also include providing at least some of the captured data to the band or media creator to assist the band in understanding consumers of their content.

In another advertising path 46, an advertiser may contact and/or otherwise agree with the website to host an advertisement 70. This may include providing the website with the advertisement to be viewed, and may further include information and/or parameters relating to how the advertisement should play, or who the advertisement may be shown to. Non-limiting examples of this related information and/or these parameters may include particular bands, groups of bands, media creators, genre of creator, genre of content, age of the viewing user, and/or gender of the viewing user. Additionally, the advertiser may include desired questions or interactive content for the user to respond to after the viewing of the advertisement, as described herein.

The website, upon agreeing with the advertiser, may place the advertisement in an active pool 72 to be viewed when a user with the selected parameters or matching attempts to obtain digital media content. For example, if an advertiser does not provide any parameters or preference for a viewing user, the ad may be used at any time for any viewing user. Furthermore, each advertiser, advertisement, parameter, and/or user response information may be given a tracking identifier such that the website may provide at least one entity, such as the advertiser, a reporting or accounting of the advertisement and/or interactions. Once the advertisement is placed in the pool of active advertisements to be viewed by users, the website may pull and/or utilize at least a portion of the member information in an attempt to match, or otherwise deliver and/or provide relevant advertisements to a particular user 74, as part of an internal process 42, described herein. For example, users of example zip code 55555 may be matched with an advertisement having selected parameters of zip code 55555.

In another band path 44, the band, band user, and/or media creator, may access the website 76, for example, though a common login page with the users, or via a dedicated band login page. The band may access the website and may either log into their account, if an account exists, or may choose to create an account, if an account does not exist. If an account does not exist, or the band would otherwise like to create and account, the band may choose a “create account” option, and may advance to a transaction wherein the band enters information to create an account 78, such as choosing a login name and creating a password. The band at this time may also, for example, confirm their band name, band members, ages, genders, zip codes, and other demographical information, as well as review and agree to a license agreement for using the distribution system. Additional band inputs may be included, and the license agreement may vary depending on the user inputs and/or demographical information.

The transaction may also limit only bands of a particular status, for example, a geographic location, minimum age, or bands having a contract with a particular entity, such as a particular grouping of recording labels, to perform the account creation. Next, the band is shown additional optional input fields 54, such as a demographical area or map wherein they may select their location, personal or professional interests, street address, school attended or attending, hobbies, and the like. Additional mandatory and/or optional band inputs may be included. These band inputs may further include information related to their content, such as genre or style, as well as their content consumer information, such as target age, gender, geographical location, etc. Once the band has completed the account creation, and the server has been updated to include the band information, the band may login to the website. Alternatively, the band may be allowed to login prior to the server updating the band information (e.g. done at a later date and/or time, or in a batch operation), or the band may need to verify input information, for example, by confirming the email address used in creating the account. Additional steps and/or transactions may be included.

Once the band has logged into the website, they may proceed to begin uploading digital media content 80, such as songs, and managing their distribution system profile. Once the digital media content has been uploaded to the website, server, and/or distribution system, the song may become part of the website song database 82, and may become searchable by a user.

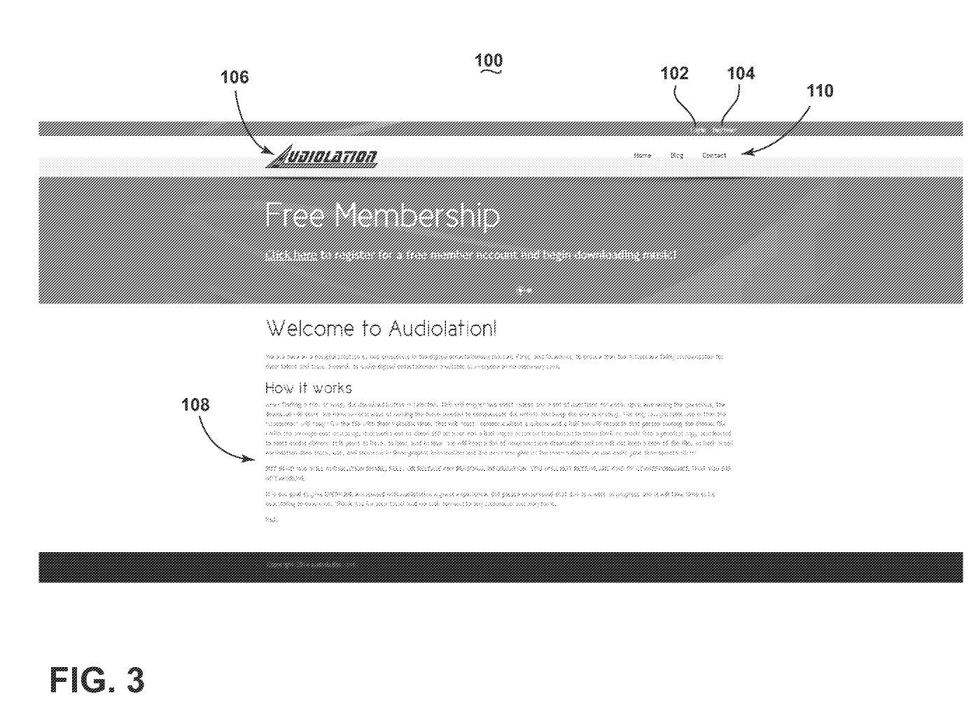

FIG. 3 illustrates an example of a user website welcome page 100 which may be used in the distribution system. The website 100 may include, for example, links to login 102 or register 104 with the website 100, website trademarks and/or branding 106. The website may further include an explanation 108 as to how the website 100 works. While particular examples of various embodiments of the website 100 are illustrated, alternative embodiments may be included with different content, layout, design, or interactivity. Furthermore, embodiments of the website 100 may include a portion of information 110 that remains constant regardless of what particular website page a viewer is viewing. For example, the portion of information 110 may include the login link 102, the register link 104, a “home” link to take a viewer to the homepage of the website, a “blog” link to take the viewer to a website-related blog, and/or a “contact” link to take the viewer to a page providing ways to contact the website staff. Additional information that is provided on all, or a subset of all webpages, may be included. In additional examples, if a website user has already logged into the website, the login link 102 may be replaced by another link, or may be removed.

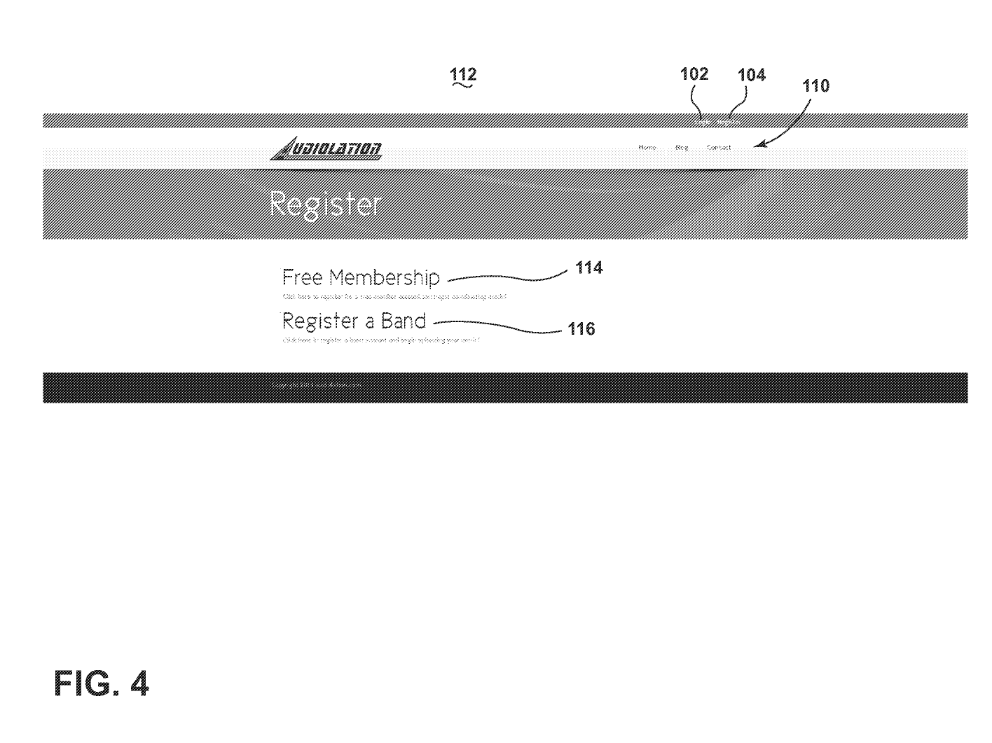

FIG. 4 illustrates an example registration website 112 that may be reached by clicking on the register link 104. On this registration website 112, a website user may be given options and/or links to register a user 114 and/or register a band 116 or media creator.

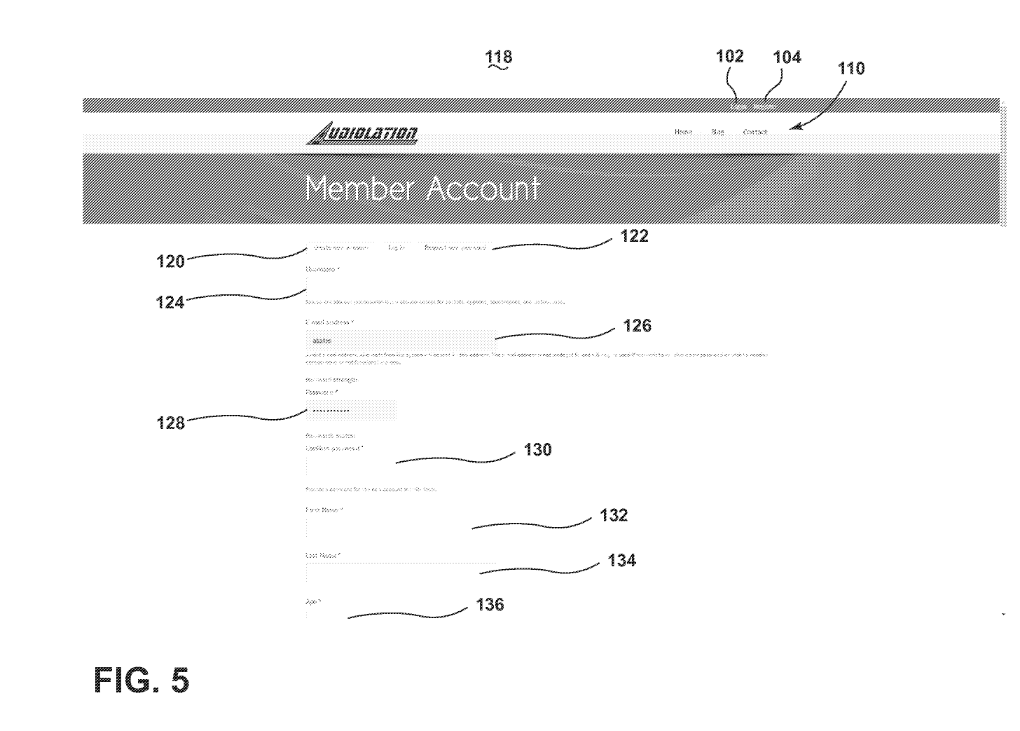

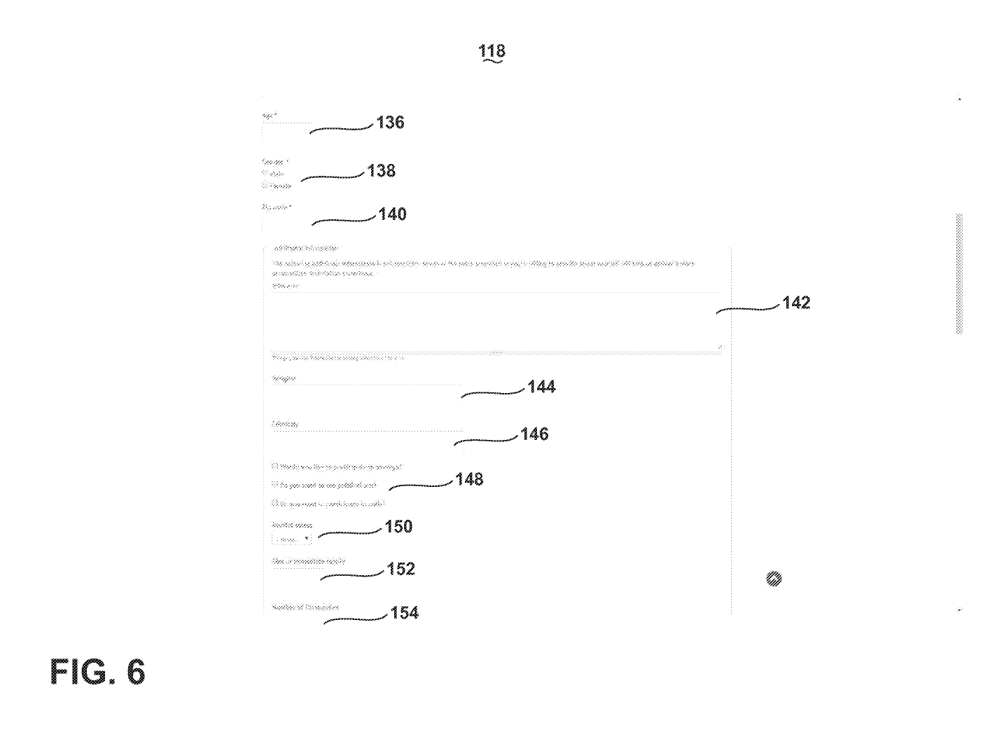

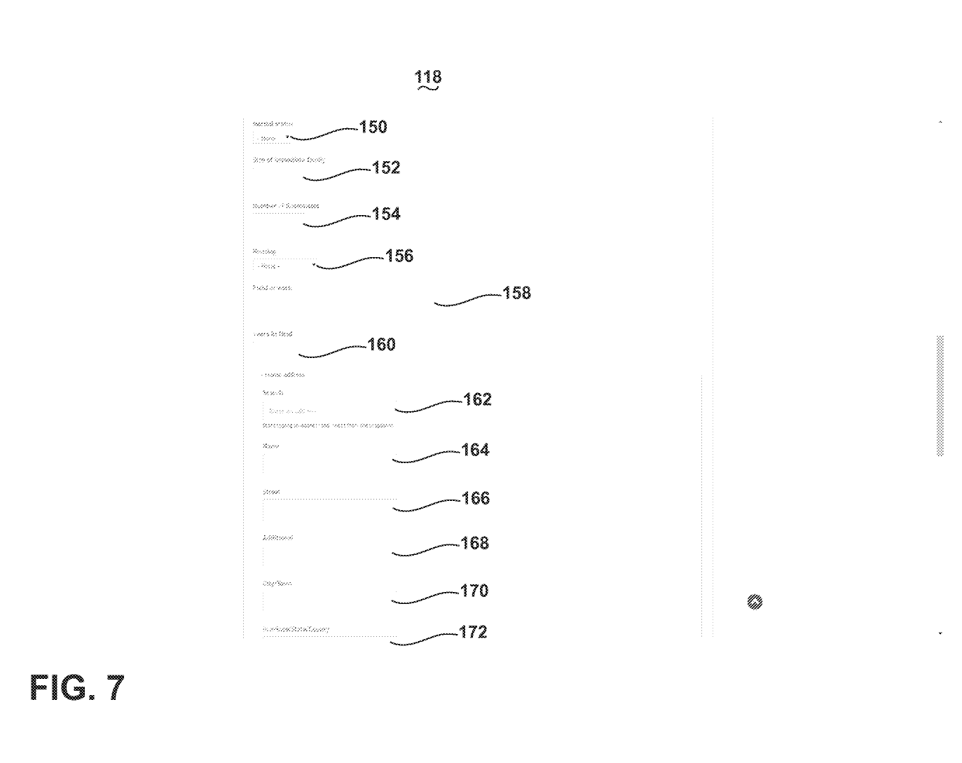

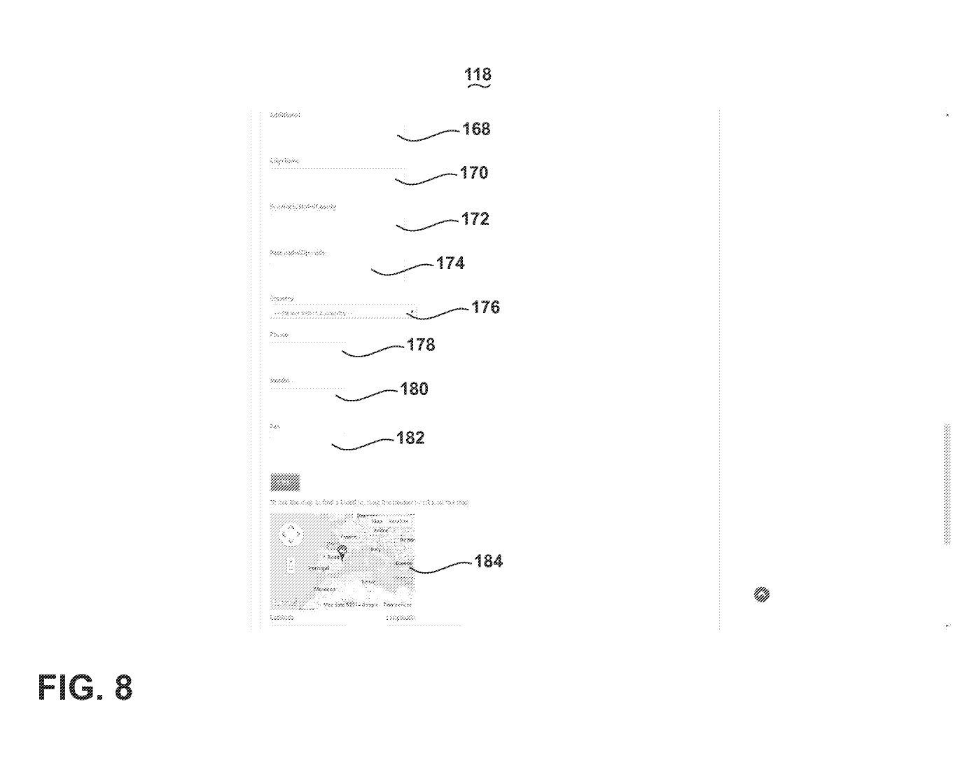

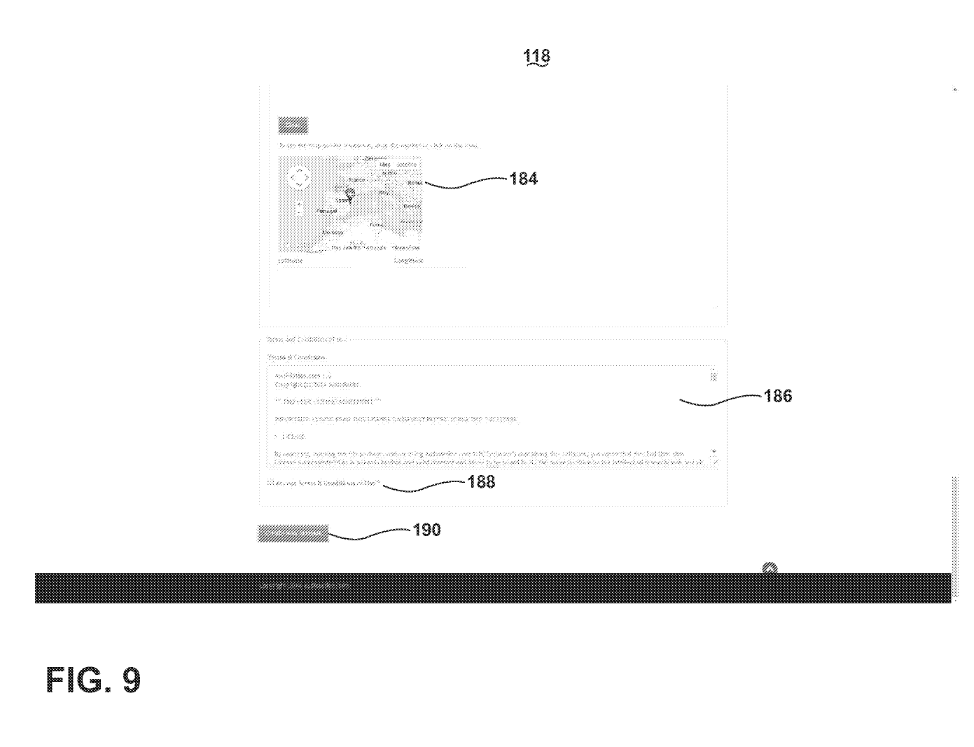

FIGS. 5 through 9 illustrate an example member account, or user account, registration website 118, for example, reachable via the register a user link 114. On this website 118, a user may, for example, create a new account 120, request a new password 122, and may include non-limiting entries for a username 124 (which may incorporate rules, such as limiting punctuation in usernames, etc.), enter an e-mail address 126, choose a password 128 (which may incorporate rules, such as requiring the inclusion of certain character types, or length of password), an input to reenter the password 130 to ensure the passwords match, a first name 132, a last name 134, age 136, gender 138, and/or zip code 140. The registration website 118, may further include non-limiting optional information entries for the user to complete, including, for example, interests 142, religion 144, ethnicity 146, specific requests to participate in surveys, political ads, and/or polls 148, marital status 150, size of immediate family 152, number of roommates 154, housing 156, field of work 158, and years in field 160.

Additional non-limiting information may be provided by the user including address 162, address name 164, street 166, additional address information 168 (e.g. apartment number, floor, etc.), city/town 170, province/state/county 172, post code/zip code 174, country 176, home phone number 178, mobile phone number 180, fax number 182, an interactive map to identify one or more entered or unentered addresses 184, terms and/or text of a license agreement 186 such as the EULA, acceptance of the terms and conditions 188, and a create account button 190 that will provide for the submission of the entered information. Embodiments of the registration website 118 may include error checking to prevent the submission of the entered information when, for example, mandatory fields are not filled in, where the username is unavailable for registration, or wherein the username and/or password do not abide by the indicated rules.

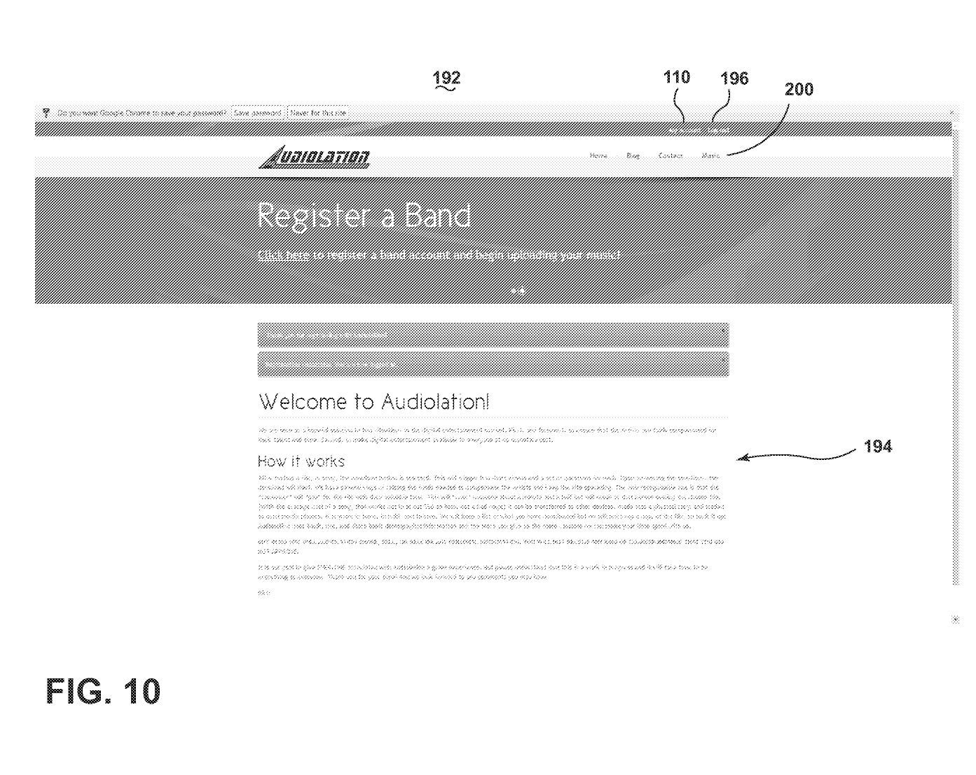

FIG. 10 illustrates an example of a media creator or band website 192 which may be used in the distribution system. The website 190 may include, for example, similar links, content, and organization of additional websites, such as the user website 100. The website may further include an explanation 194 as to how the website 192 works, tailored to a band's perspective. The website 192 of FIG. 10 further illustrates that after login, the login link 102 may be replaced with a my account link 196, the register link 104 may be replaced with a logout link 198, and an additional link to music 200 may be included, which may, for example, take a band user to the music the band has included in the distribution system, or may take a user to the music they have already obtained.

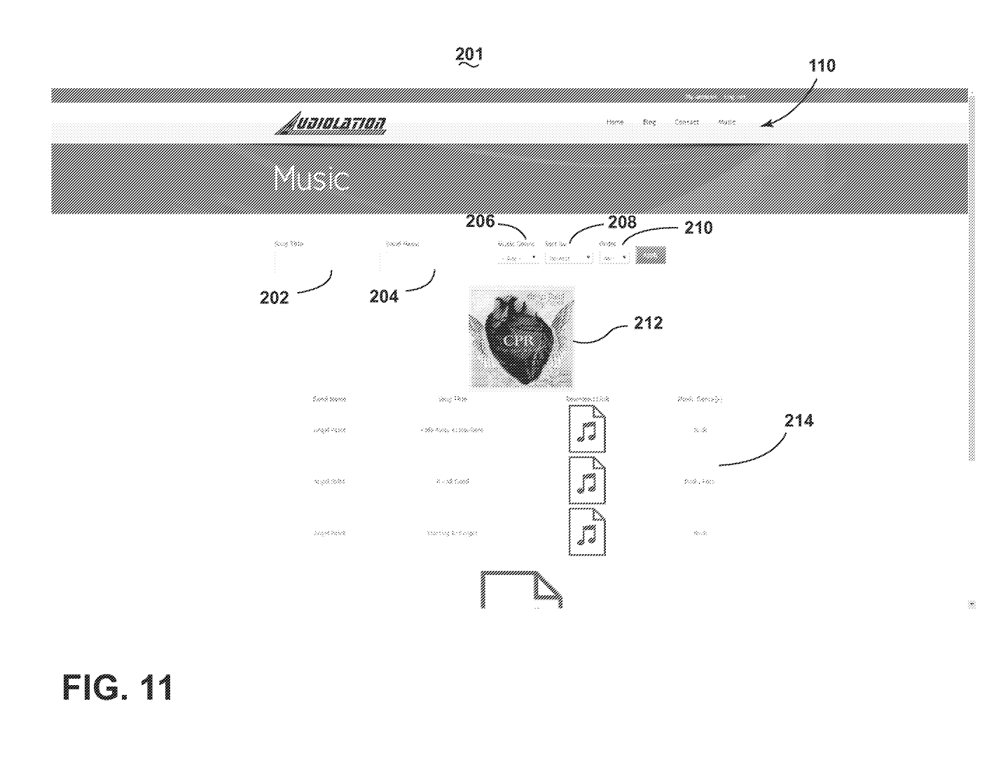

FIG. 11 illustrates one example embodiment of a user search page 201 wherein a user may search for digital media content. As shown, the search page 201 may include non-limiting entries elements to for searching the digital media content database by way of song title 202, band name 204, music genre 206, and options to sort by 208, and/or sort order (ascending or descending) 210. The search results may include album art 212, and a listing of digital media content entries 214 based on the search, including example download links.

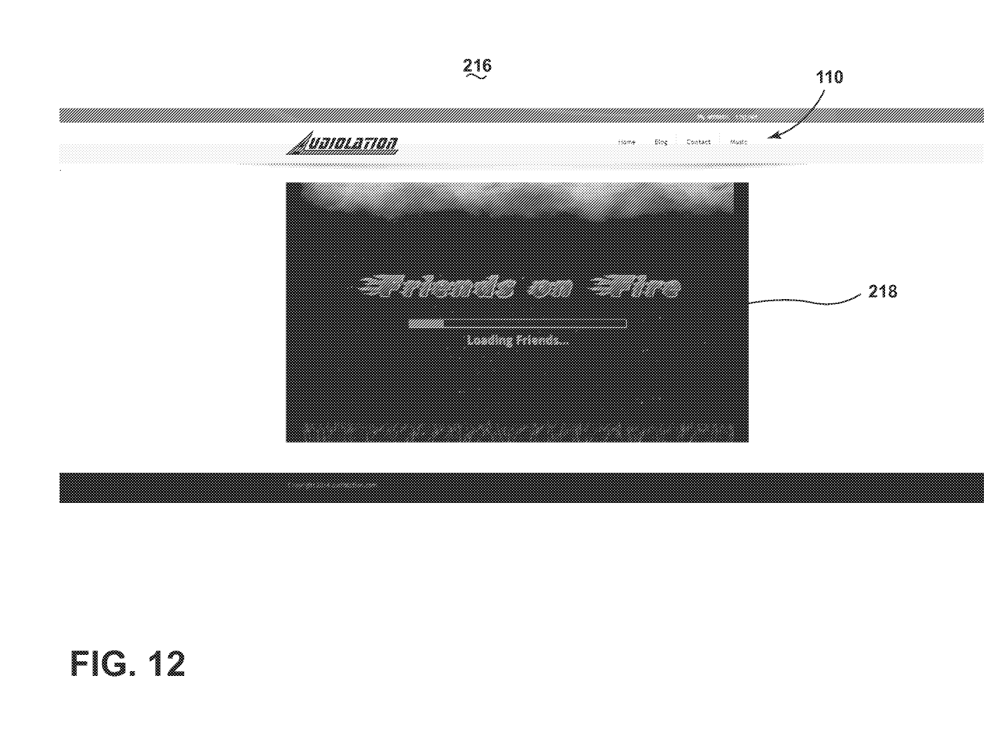

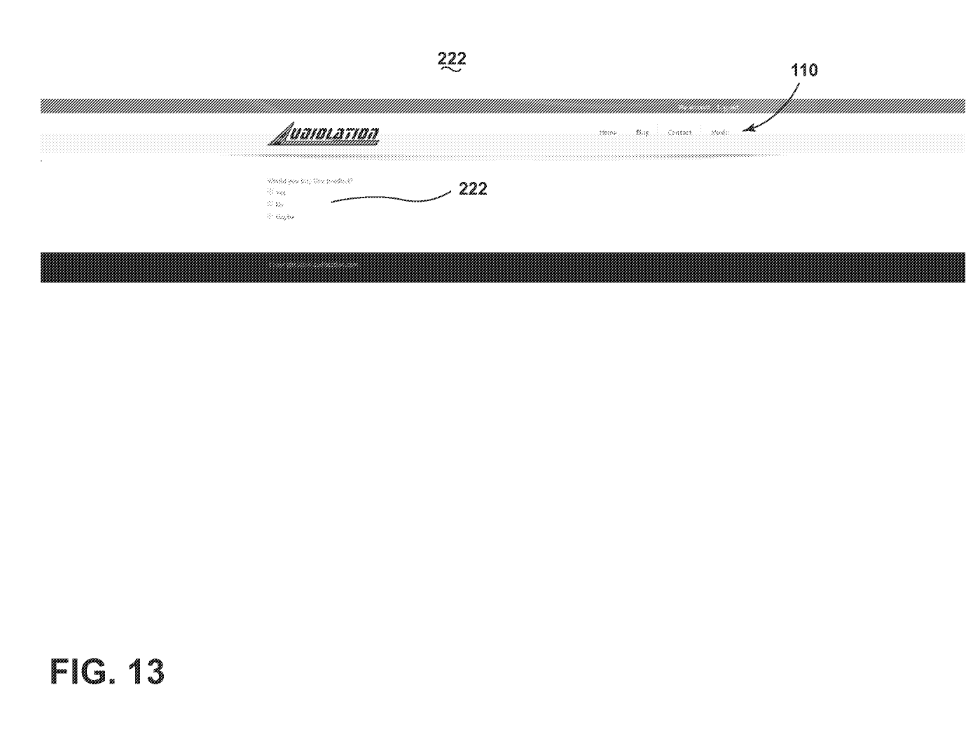

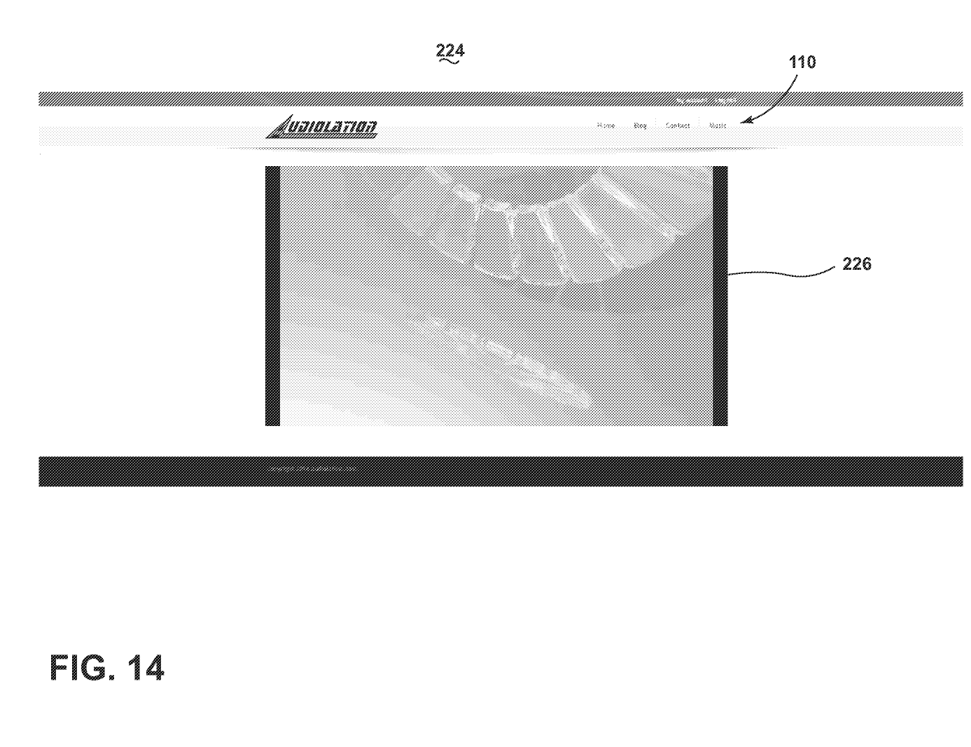

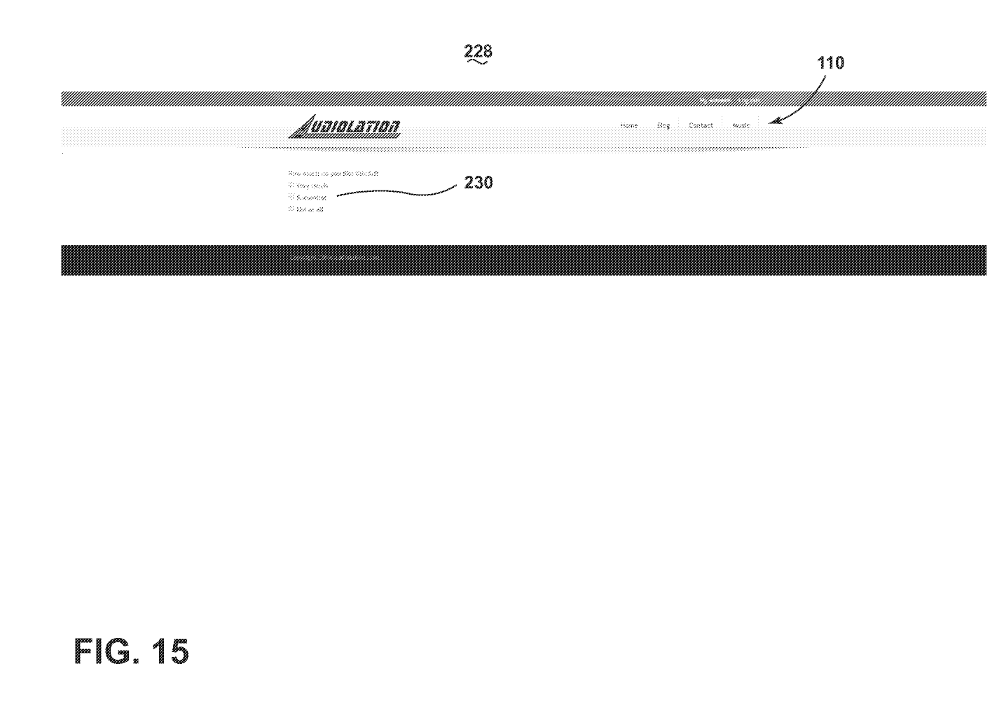

FIG. 12 illustrates one example embodiment of an advertisement website 216 including an example video ad 218 viewable by a user. While a video ad 218 is shown, additional advertising forms such as text and pictures may be included. FIG. 13 illustrates an example response website 220, wherein a user may enter comments or respond to predetermined questions 222 after watching one or more advertisements, as described herein. While FIG. 13 is illustrated as a different website 220 than the advertisement website 216, embodiments of the invention may include at least a portion of content from each website 216, 220 on a single website. FIG. 14 illustrates another example embodiment of an advertisement website 224 including an example ad 226 viewable by a user. FIG. 15 illustrates another example response website 228, wherein a user may enter comments or respond to predetermined questions 230 after watching one or more advertisements, as described herein.

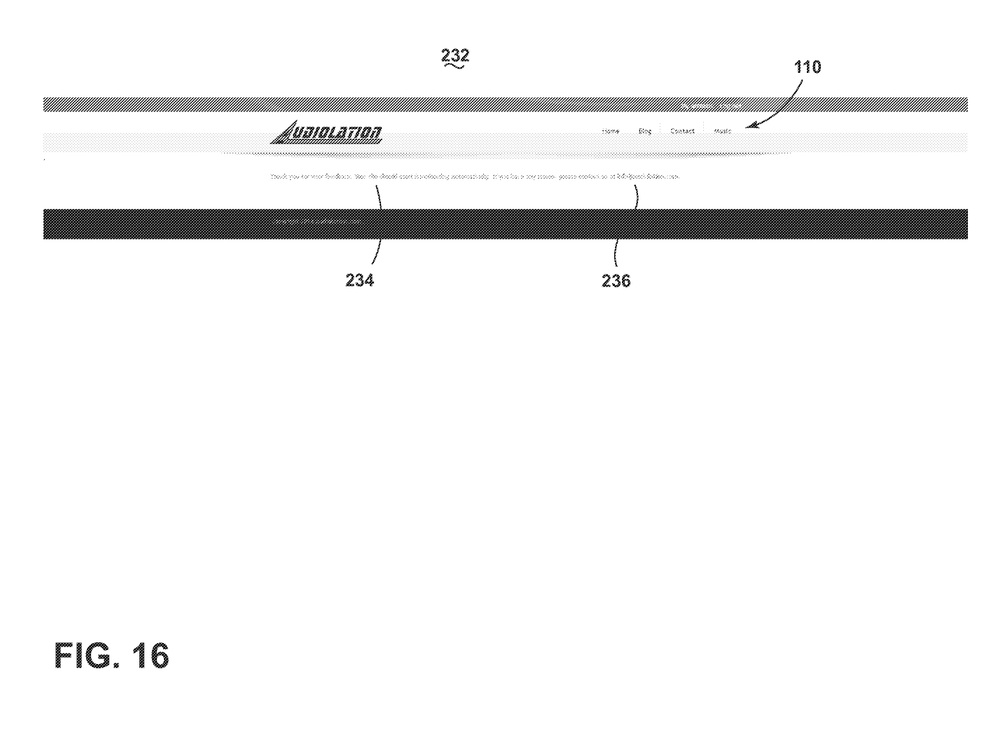

FIG. 16 illustrates a confirmation website 232, wherein a user is presented a message 234 stating that the predetermined transaction has been completed, and that, for example, the download link will be generated, or alternatively, that the download of the digital media content will start automatically. The webpage 232 may also include a link to contact website staff 236 if issues arise.

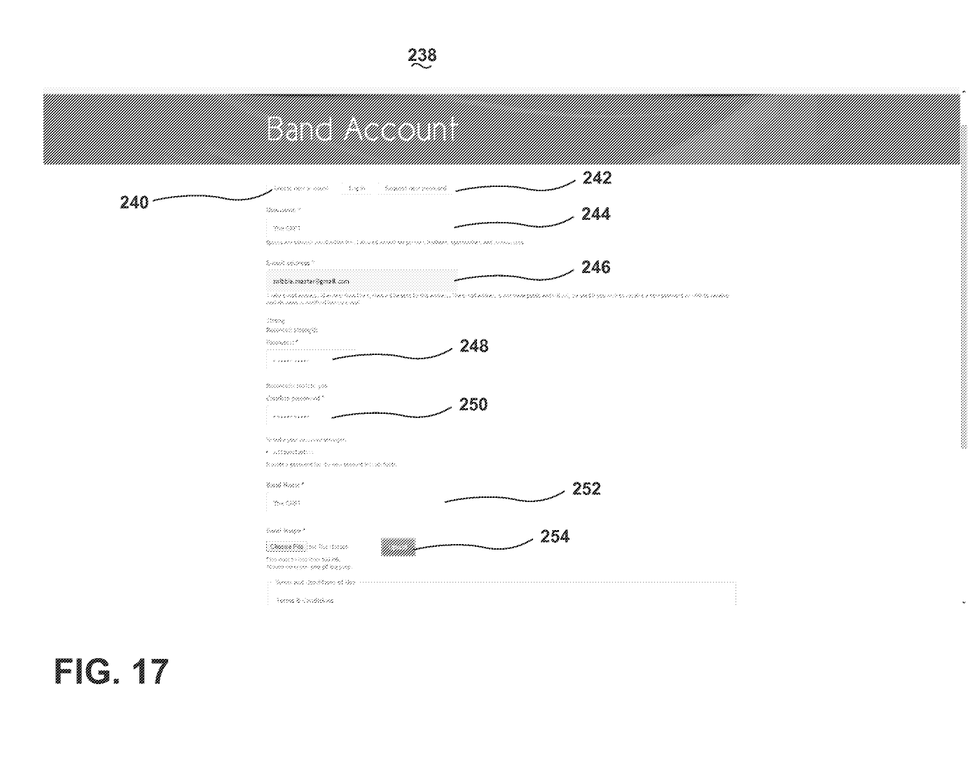

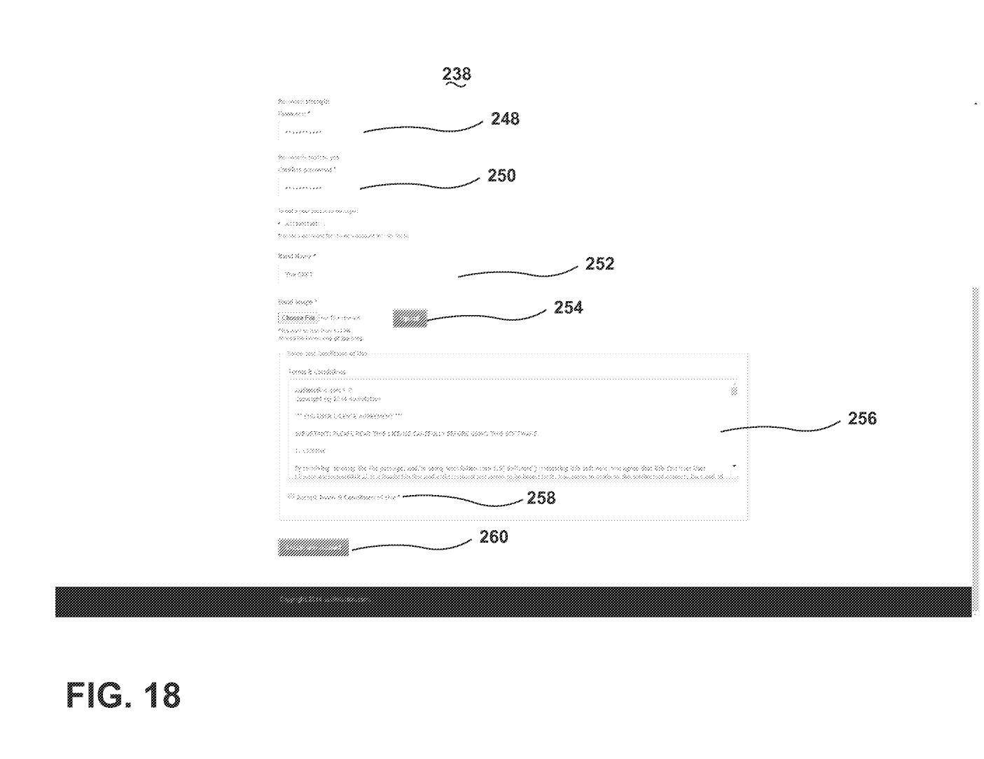

FIGS. 17 and 18 illustrate and example band account registration website 238, for example, reachable if a website user follows the register a band link 116 of FIG. 4. On this website 238, a band user may, for example, create a new account 240, request a new password 242, and may include non-limiting entries for a username 244 (which may incorporate rules, such as limiting punctuation in usernames, etc.), enter an e-mail address 246, choose a password 248 (which may incorporate rules, such as requiring the inclusion of certain character types, or length of password), an input to reenter the password 260 to ensure the passwords match, enter a band name 252, upload a band image 254 including an entry to choose an image file and an upload button, as well as any rules for image upload (e.g. data size and/or file type restrictions), terms and/or text of a license agreement 256, acceptance of the terms and conditions 258, and a create account button 260 that will provide for the submission of the entered information. Embodiments of the registration website 238 may include error checking to prevent the submission of the entered information when, for example, mandatory fields are not filled in, where the username is unavailable for registration, or wherein the username and/or password do not abide by the indicated rules.

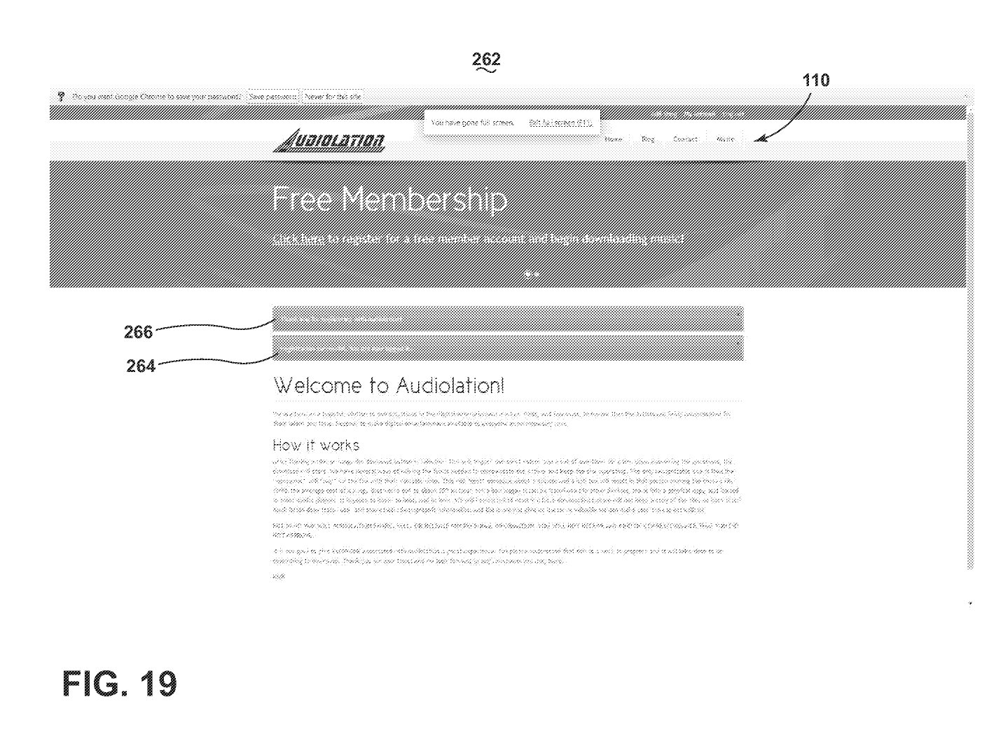

FIG. 19 illustrates an example website 262, wherein after registering as a user or a band, the website 262 provides indication that the registration was successful and that they are now logged in 264 and/or thanking the website user for registering 266. Other aspects of the website 262 may be duplicative of another website described herein.

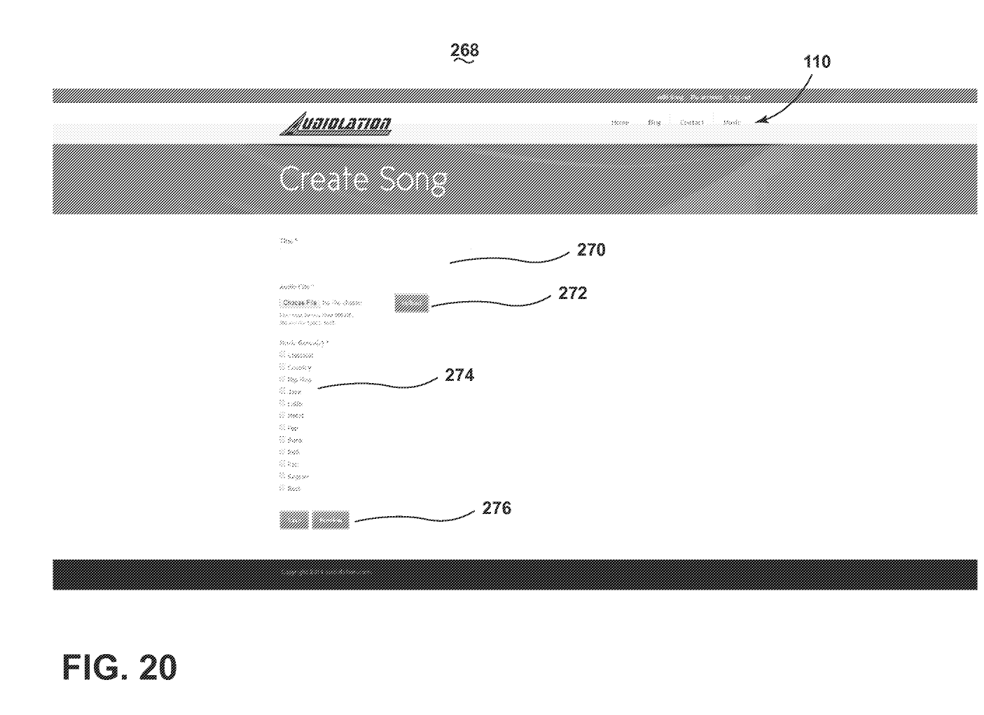

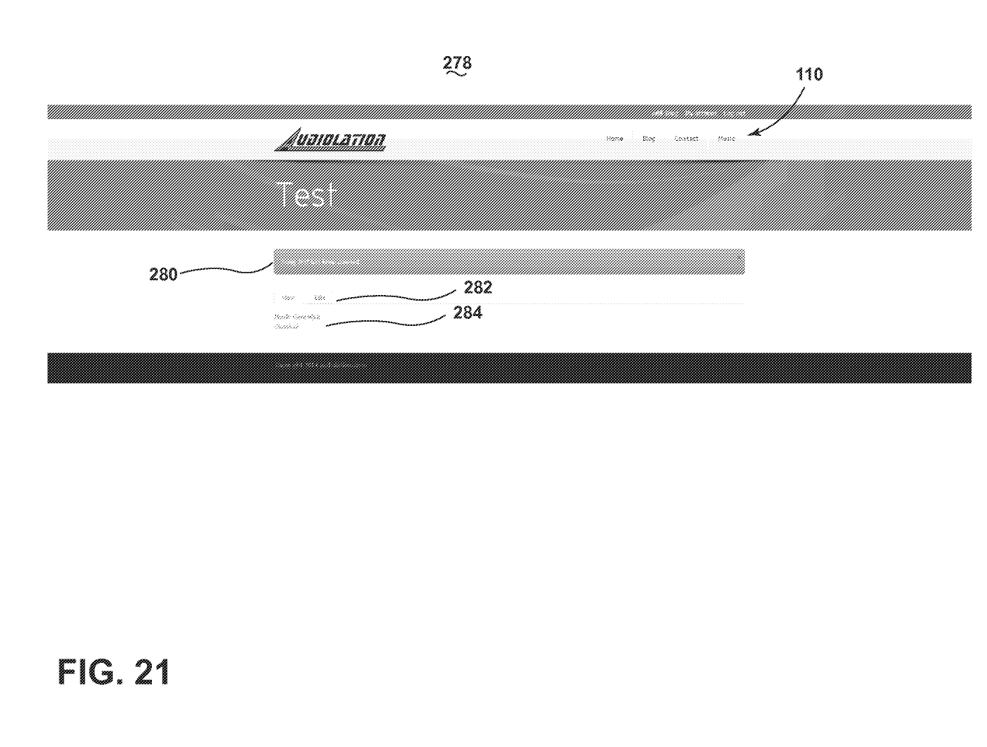

FIG. 20 illustrates an example website 268 wherein a band may create and/or upload a digital media content file, such as a song. The website 268 may include non-limiting entries for the song title 270, upload a media content file such as song 272 including an entry to choose an song file and an upload button, as well as any rules for song upload (e.g. data size and/or file type restrictions), selectable music genre(s) 274 for the music file, and save and/or preview buttons 276 for, respectively, saving the music file to the searchable database, or previewing the uploaded music file. Once the band user saves the uploaded music file to the searchable database, the band user may be redirected to another website 278, shown in FIG. 21, which may provide an indication that the music entry has been created 280, options to view or edit 282 the music entry, and/or the music genres selected 284.

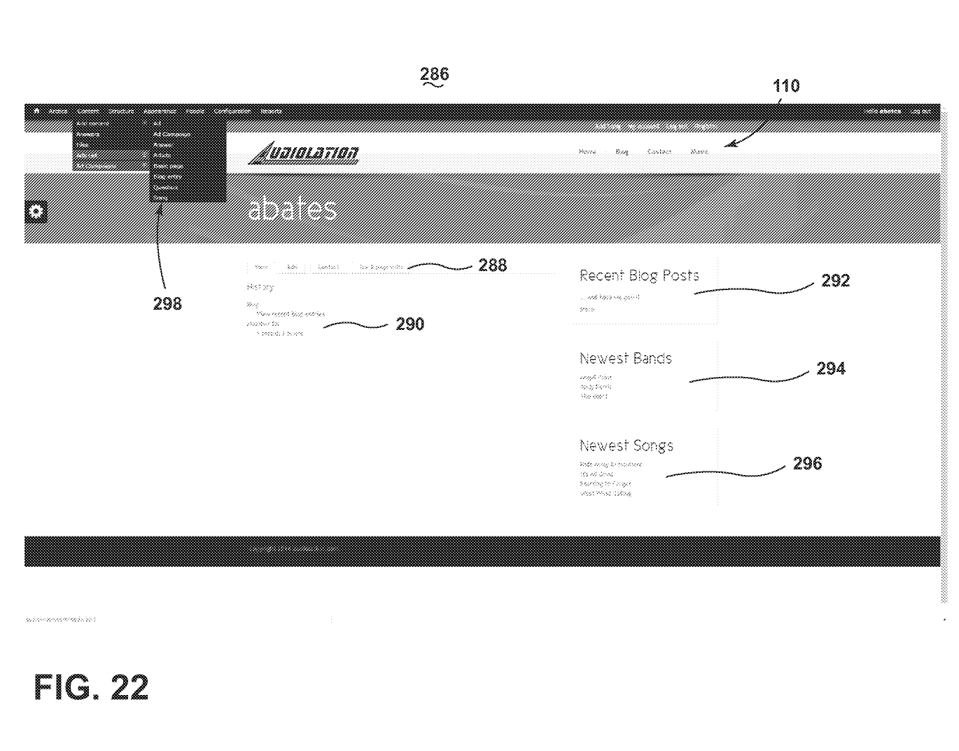

FIG. 22 illustrates a website administration portal 286 or website, wherein a website administrator may view and/or edit website content. The portal 286 may include non-limiting interfaces to view, edit, contact, or track page visits 288 with respect to a particular advertiser, end user, or band, a history 290 of the system administrator, or alternatively, of the end user, band, or advertiser, showing past transactions, recently entered blog posts 292, newest bands 294 on the website, and newest songs 296 on the website. The administrator portion 286 may further allow for a menu 298 to add and/or update advertisements, ad lists, ad campaigns, blog entries, articles, songs, questions, etc., and the like.

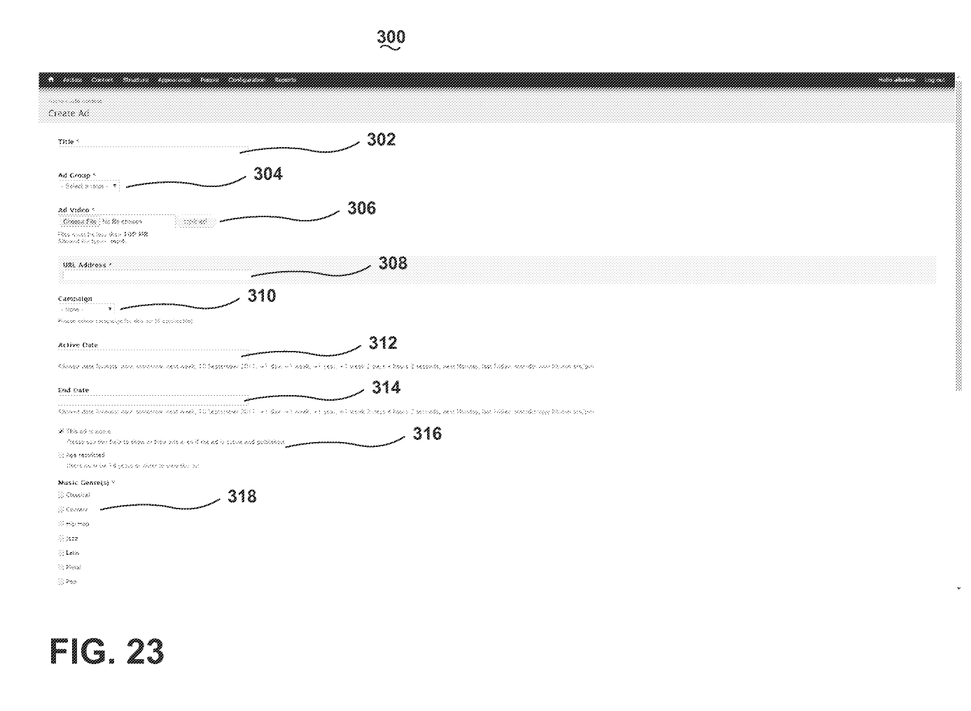

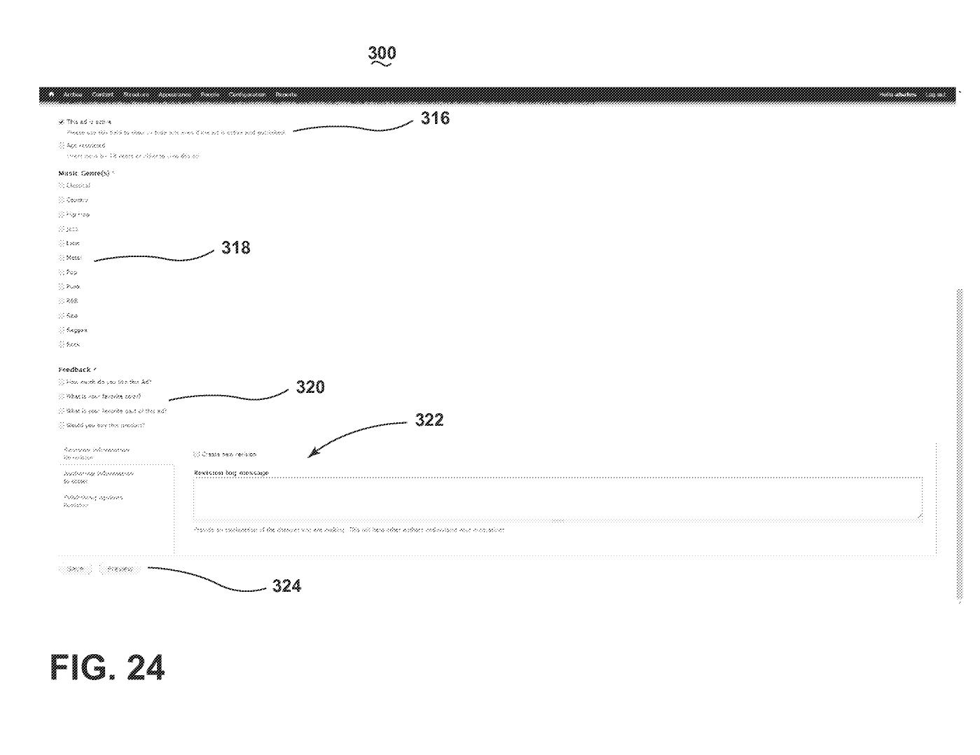

FIGS. 23 and 24 illustrate a website interface 300 for adding a new advertisement. Non-limiting entries for a new advertisement may include entries for an advertisement title 302, ad group 304, upload an advertisement file 306 including an entry to choose an ad file and an upload button, as well as any rules for ad upload (e.g. data size and/or file type restrictions), URL address 308 related to the advertisement, a campaign 310, active date 312 or start date for releasing the ad, end date 314, selections 316 for if the ad is active and/or restrictions such as age restrictions for the ad, selectable music genre(s) 318 that the ad may be associated with, specific feedback questions 320 or responses desired, revision tracking of the advertisement 322, and a save and/or preview button 324.

While many entries for different websites are listed herein, any combinations of mandatory and/or optional entries are envisioned. Furthermore, additional entry fields may be included. Each of the entry fields may be provided in a number of different entry types, including but not limited to, text fields, checkboxes, radio-buttons, submit buttons, singly or multi-selectable lists, text area, field set, legend, and/or label elements.

The technical effect is that the above described embodiments enable the secure distribution of media at no cost to the consumer, while guaranteeing that advertisers will have their ads viewed by users. Many other possible embodiments and configurations in addition to that shown in the above figures are contemplated by the present disclosure. While embodiments described are directed towards music, additional media forms may be included in embodiments of the invention, including books, tv, music, newsprint, magazines, movies, etc.

To the extent not already described, the different features and structures of the various embodiments may be used in combination with each other as desired. That one feature may not be illustrated in all of the embodiments is not meant to be construed that it may not be, but is done for brevity of description. Thus, the various features of the different embodiments may be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of operating a computer-implemented media distribution system over a global computer network, comprising the steps of:
receiving a request from an authenticated user for at least one unit of media;
providing a response to the request with at least one computer-selected advertisement;
requiring the authenticated user to consume the at least one computer-selected advertisement and provide a response representative of the completion of the consumption of the at least one computer-selected advertisement;
receiving the response representative of the completion of the consumption of the at least one computer-selected advertisement from the authenticated user;
validating the response representative of the completion of the consumption of the at least one computer-selected advertisement from the authenticated user; and
providing, upon a successful validation step, the at least one unit of media in downloadable form to the authenticated user over the global computer network.

2. The method of claim 1 wherein the step of receiving a request from an authenticated user for at least one unit of media comprises the step of receiving a request from an authenticated user for a plurality of units of entertainment media.

3. The method of claim 1 wherein the step of providing a response to the request with at least one computer-selected advertisement comprises an audiovisual advertisement and at least one question to be presented to the authenticated user.

4. The method of claim 3 wherein the at least one question to be presented to the authenticated user in a multiple-choice user interface.

5. The method of claim 4 wherein the step of providing a response representative of the completion of the consumption of the at least one computer-selected advertisement includes the step of selecting at least one of the multiple-choice responses on the user interface.

6. The method of claim 1 wherein the authenticated user has at least one demographic data element associated with it and the at least one computer-selected advertisement comprises an advertisement responsive to the at least one demographic data element.

7. The method of claim 6 wherein the step of providing a response to the request with the at least one computer-selected advertisement includes selecting the at least one computer-selected advertisement based on a correlation between the at least one demographic data element associated with the authenticated user and at least one target demographic data element associated with the at least one computer-selected advertisement.

8. The method of claim 7 wherein the step of providing a response to the request with the at least one computer-selected advertisement includes determining whether the correlation between the at least one demographic data element associated with the authenticated user and at least one target demographic data element associated with the at least one computer-selected advertisement satisfies a correlation threshold.

9. The method of claim 6 wherein the at least one demographic data element includes at least a two of name, age, gender, address, zip code, phone number, religion, ethnicity, marital status, family size, number of roommates, housing status, field of work, years in field of work, personal or professional interests, school attended or attending, or hobbies.

10. The method of claim 1 wherein the step of requiring the authenticated user to consume the at least one computer-selected advertisement further includes determining whether the authenticated user is using at least one of a program or software configured to prevent the authenticated user from consuming the at least one computer-selected advertisement.

11. The method of claim 10 further including, when the step of determining concludes the program or software configured to prevent the authenticated user from consuming the at least one computer-selected advertisement is being used, not providing the least one unit of media in downloadable form to the authenticated user over the global computer network.

12. The method of claim 10 further including, when the step of determining concludes the program or software configured to prevent the authenticated user from consuming the at least one computer-selected advertisement is being used, providing the authenticated user a message indicating that a program or software is being configured to prevent the authenticated user from consuming the at least one computer-selected advertisement is being used.

13. The method of claim 1 wherein the step of providing the at least one unit of media in downloadable form to the authenticated user over the global computer network further includes providing the authenticated user a single-use download link, such that the link is only operational to download the at least one unit of media once.

14. The method of claim 1 further comprising logging the step of providing the at least one unit of media in downloadable form to the authenticated user.

15. The method of claim 14 further comprising compensating a rights-holder for the at least one unit of media based on the logging.
